(19) United States
(12) Patent Application Publication
(10) Pub. No.: US 2019/0001827 A1
(43) Pub. Date: Jan. 3, 2019

(54) WIRELESS COUPLING FOR COUPLING A VEHICLE WITH AN ELECTRONIC DEVICE DISPOSED IN AN INTERIOR PART OF THE VEHICLE

(71) Applicant: GRUPO ANTOLIN-INGENIERIA, S.A.U., Burgos (ES)

(72) Inventors: Álvaro PÉREZ VALLEJO, Burgos (ES); Óscar GARCÍA PÉREZ, Burgos (ES)

(21) Appl. No.: 16/019,048

(22) Filed: Jun. 26, 2018

(30) Foreign Application Priority Data
Jul. 3, 2017 (EP) 17382428.5

(51) Int. Cl. B60L 11/18; H04B 5/00; H02J 50/10

(52) U.S. Cl. CPC B60L 11/182; H04B 5/0075; H04B 5/0037; H02J 2007/0096; H02J 50/10; H04B 5/0031; H04B 5/0012

(57) ABSTRACT

A wireless coupling for simultaneously communicating with a vehicle and feeding from said vehicle an electronic device disposed in a vehicle interior part disposed inside the vehicle, by means of an NFC technology. The coupling includes a first-end powering transceiver located in a fixed position within the vehicle, having: a connection component electrically connectable to a wiring system of the vehicle, a first end ECU, first-end RF transceiving component, a first-end EMC filter, and a first-end antenna showing certain first-end impedance Zx. It also includes a second-end powered transceiver configured to be disposed in a vehicle part in which the electronic device is disposed. The second-end powered transceiver includes second-end RF transceiving component and a second-end antenna showing certain second-end impedance Zy. The wireless coupling includes a matching circuit with an impedance Zc and connected to the first-end or the second-end antenna, this first-end or second-end antenna having a first-end or a second-end antenna design impedance Z_{2da}, respectively more inductive than the corresponding theoretical first-end or second-end antenna impedance Z₂ₜₐ, such that the combination of the design first-end or design second-end antenna impedance Z_{2da} and the impedance Z_{C} of the matching circuit matches the theoretical first-end or the theoretical second-end antenna impedance Z₂ₜₐ.

### CROSS-REFERENCE TO RELATED APPLICATIONS

This application is related to and claims the benefit of Spanish Patent Application No. EP17382428.5, filed on Jul. 3, 2017, the contents of which are herein incorporated by reference in their entirety.

### TECHNICAL FIELD

The present disclosure pertains to the field of coupling a vehicle and electronic devices integrated in interior parts mounted inside the vehicle. More particularly, it refers to those interior parts having electronic devices, like sensors, signaling lights, lightings, actuators, among others, which need be coupled to a vehicle, for its feeding/powering and/or for data exchanging inside the vehicle, in a wireless way.

### BACKGROUND

Vehicle interior parts often comprise electronic devices.

These electronic devices must be coupled to the vehicle for providing them at least electric feeding, and transmitting some basic info, like passive device identification, simple commanding instructions, or state change info. Sometimes, this information could include more complex communication between an electronic device and the vehicle, exchanging more complex monitoring, or commanding data, using for instance a CAN bus standard.

Typically, these electronic devices are connected to the vehicle by a wired circuit, which involves complex designs for the layout of the wires and the use of connectors, increasing costs and weight. These wired circuits demand much room available inside the vehicle interior, this way, penalizing the interior vehicle habitability, which in turn requires great design and implementation efforts due to these space constraints inherent to the vehicle structure.

As an alternative to wired connections, there are some wireless couplings for either, communicating an electronic device with the vehicle CPU, or for feeding them. Usually, these wireless couplings have dedicated designs, being either, for transmitting power, but without data transmission, like for instance wireless chargers, or for some kind of more or less complex pure data exchanging, like for instance blue-tooth technology.

Patent US2017158063 can be an example of a wireless charging system for vehicle. This patent describes a wireless charging system for a vehicle based on the principle of transmitting and receiving electric power using electromagnetic induction or resonance. In this particular case, a high electric power transmission is used to charge a battery applied to an electrical vehicle, and this power transmission is done by improving the charging efficiency, recovering part of the heat generated during the battery charging. Any data transmission is claimed in this patent.

Patent US2014218189 can be another example of prior art, in this case, for data transmission via blue-tooth technology. In this case, it is shown a device for data transmission, but without significant power transmission. This patent describes an apparatus for alerting a user of an item present within a vehicle, by messages exchanged between and active near-field communication device, and a passive near-field communication device, using blue-tooth technology.

Additionally, EMC requirements, jointly with the maximum admissible radiated power level inside the vehicle, add even more complexity to the design of wireless couplings for electronic interior vehicle parts.

Among the possible wireless coupling systems, one known possibility, suitable for vehicle interiors, is the use of a NFC technology. Due to the very short-range of this kind of couplings, it is relatively easy to comply with EMC requirements, but one problem with these systems is that they usually are not aimed for transmitting big amounts of power, and then, they are not able to transmit enough power for feeding electronics devices.

Besides, unlike in other environments, in a vehicle the cited functionalities must be performed following very demanding requirements, constraints, and high communication quality levels. Maintaining such high quality levels of signal is usually achieved by the use of tailor-made, dedicated devices.

The wireless coupling requires the tuning of the frequency chosen for the transmission of data between the both sides to be coupled, one in the vehicle, and the other in the vehicle interior part where the electronic device is assembled. This in turn requires the matching of the impedances at both ends. One problem related to this, is that some factors may cause different impedance variations at both sides, and consequently an impedance mismatch for the chosen transmission frequency, what affects the quality and intensity of the signals transmitted.

Among others, these factors can be related to the relative position between both sides, mainly the distance between the antenna of electronic device and the antenna of the vehicle, the placement of the coupling device inside the vehicle, and related with this the distribution of metal parts of the vehicle surrounding it, what deviates the effective impedances of the antennas at such working conditions, from their theoretical values, modifying as well the total impedances of their corresponding transceivers, and this way causing a mismatch between them, dismissing the quality and the efficiency of the coupling between both ends.

Other factors can be related with the environmental conditions, like the ambience humidity and the temperature, the components ageing, or the different kinds of inner part and vehicle models to be coupled. This implies that, on one hand, there is always a loss of quality regarding the theoretical behavior, and on the other hand, such wireless devices must be designed ad-hoc, depending on the vehicle brand and model, lacking standardization, what significantly increases development complexity and manufacturing costs.

### SUMMARY

The device described in the present disclosure intends to solve the shortcomings of prior-art devices for wirelessly coupling a vehicle and electronic devices attached or integrated in a vehicle interior part inside the vehicle. The wireless coupling comprises simultaneously data exchange by means of a RF signal, between the electronic devices and the vehicle, and simultaneously feeding the electronic devices from said vehicle. At the same time, this device maximizes the degree of standardization, minimizing this way additional cost and design efforts, needed either, for adapting a same wireless coupling to different designs and configurations, or for compensating impedance deviations due to ageing of the components and to environmental factors.

The disclosure provides a wireless coupling based on NFC (Near Field Communication) technology, working at a given transmission frequency.

A first aspect of the disclosure relates to a wireless coupling, comprising:

a first-end powering transceiver located in a fixed position within the vehicle and showing certain first-end impedance Z₁ when working at the transmission frequency and

a second-end powered transceiver configured to be disposed in the vehicle interior part in which said electronic device is disposed, said electronic device being connected to the second-end powered transceiver. The second-end powered transceiver being configured to operate at a radio frequency range emitted by the first—end antenna of the first-end powering transceiver. The second-end powered transceiver showing certain second-end impedance Z₂ when working at the transmission frequency.

The first-end powering transceiver comprising:
connection means electrically connectable to a wiring system of the vehicle,
a first-end ECU,
a first-end RF transceiving means,
a first-end EMC filter, and
a first-end antenna with a theoretical first-end antenna impedance Z₁ₜₐ at the transmission frequency.

The second-end powered transceiver comprises
a second-end RF transceiving means and
a second-end antenna showing certain theoretical second-end antenna impedance Z₂ₜₐ at the transmission frequency;

According to the disclosure, the wireless coupling comprises a matching circuit with an impedance Zc, said matching circuit being arranged to compensate any deviation from the theoretical first-end impedance Z₁ₜₐ, or from the theoretical second-end impedance Z₂ₜₐ, due to real working conditions. The matching circuit is connected to the first-end antenna, or to the second-end antenna, this first-end antenna or second-end antenna, having respectively a first-end antenna design impedance Z_{1da}, or a second-end antenna design impedance Z_{2da}, more inductive than the corresponding theoretical impedance Z₁ₜₐ of the first-end antenna or than the theoretical impedance Z₂ₜₐ of the second-end antenna, such that the combination of the design impedance Z_{1da} of the first-end antenna or of the design impedance Z_{2da} of the second-end antenna, and the impedance Z_{C} of the matching circuit, matches the theoretical first-end antenna impedance Z₁ₜₐ or the theoretical second-end antenna impedance Z₂ₜₐ.

Thus all the impedances within either, the first-end transceiver, or the second-end transceiver, are rebalanced to its theoretical design conditions, matching the first-end impedance Z₁ with the second-end impedance Z₂ and this way optimizing the quality and the efficiency of the coupling under real working conditions.

The matching circuit comprises at least one capacitive component.

In this text, the term “powering” refers to the capacity or functionality of a transceiver to provide power/energy to feed a remote transceiver, referred to in this text as “powered transceiver”. According to this, the first-end powering transceiver is somehow fed by the power system of the vehicle, and part of its power is wirelessly transmitted to the second-end powered transceiver, and consequently to the electronic device connected to it.

In some embodiments the second-end powered transceiver can comprise a second-end ECU for the processing of orders and data either, from the vehicle, or from the electronic device connected to the second-end powered transceiver.

In some embodiments, the first-end ECU of the first-end powering transceiver comprises the first-end RF transceiving means.

The vehicle interior part to which the electronic device is associated can be detachable from the vehicle either, for repair and replacement purposes, or for allowing the occupants placing it according to their preferences of use.

In some embodiments, the data exchange comprises data and/or instructions sent from de vehicle to the electronic device of the vehicle interior part.

In some embodiments, the data exchange comprises data and/or instructions sent from the electronic device of the vehicle interior part to the vehicle.

In some embodiments, the data exchange comprises data and/or instructions exchange in a bidirectional way.

In some embodiments, the first-end powering transceiver can be configured to passively detect and/or identify the second-end powered transceiver, and consequently the corresponding interior part when it is coupled to the vehicle, that is, without any active data transmission from the second-end powered transceiver. For this function, the first-end powering transceiver can be preferably configured to passively identify the second-end powered transceiver as a RFID tag.

In some preferred embodiments, the Near Field Communication (NFC) technology is a Radio Frequency Identification (RFID) technology, working in the frequency band of 13.56 MHz.

In some preferred embodiments, the first-end antenna and/or said second-end antenna are respectively implemented by means of a loop.

In some embodiments the second-end powered transceiver, comprises a memory configured to store data associated to the second-end powered transceiver and/or the electronic device disposed in the vehicle interior part to which the second-end powered transceiver is attachable.

In some embodiments, the second-end powered transceiver comprises a battery configured to be rechargeable from power harvested from the RF signal emitted by the first-end powering transceiver.

Additionally, in some embodiments, the memory of the second-end powered transceiver can be powered by the battery. That means, for instance, that it is possible to keep the electronic device connected to the second-end powered transceiver working when it is detached from the vehicle, and then, allowing changing the position of the vehicle interior part inside the vehicle, keeping its configuration, even for taking it to be used outside the vehicle.

In some embodiments of the disclosure, the impedance matching circuit can be self-adjusting, tuning its capacitive impedance to compensate any mismatch related to impedance variations due to design, environmental, or ageing factors.

In a preferred embodiment, the impedance matching circuit is comprised in the first-end powering transceiver.

In some embodiments of the disclosure, for example when the first-end antenna of the first-end powering transceiver is integrated in a metallic environment, a ferrite may be included in order to prevent the electromagnetic field from being absorbed by the metal and to confine the electromagnetic field towards the second-end antenna. The inclusion of a ferrite may be taken into account when establishing permeability parameters, losses and impedance with respect to the frequency of operation.

In some embodiments, the first-end antenna is longer than the second-end antenna. The first-end antenna is configured for either, admitting different positions of a single second-end antenna, or simultaneously coupling several second-end antennas.

In some embodiments, the first-end powering transceiver comprises a plurality of first-end antennas, covering a surface larger than that of the second-end antenna. The first-end antennas are configured for either, admitting different positions of a single second-end antenna or simultaneously coupling several second-end antennas.

Another aspect of the disclosure relates to a vehicle comprising therein a vehicle interior part comprising an electronic device, the vehicle further comprising the wireless coupling device wherein the first-end powering transceiver is located in a fixed position within the vehicle and the second-end powered transceiver is attached to said vehicle interior part.

### BRIEF DESCRIPTION OF THE DRAWINGS

To complete the description and in order to provide for a better understanding of the disclosure, a set of drawings is provided. Said drawings form an integral part of the description and illustrate an embodiment of the disclosure, which should not be interpreted as restricting the scope of the disclosure, but just as an example of how the disclosure can be carried out. The drawings comprise the following figures:

FIG. 1 shows a diagram illustrating a wireless coupling device to be disposed inside a vehicle, comprising a first-end powering transceiver and a second-end powered transceiver, in accordance with one embodiment of the disclosure.

FIG. 2 shows in detail a portion of the first-end powering transceiver shown in FIG. 1.

FIG. 3 shows a possible implementation of an antenna loop.

FIG. 4 shows a scheme of the equivalent circuit of a second-end powered transceiver in accordance with one embodiment of the disclosure comprising a matching circuit.

FIG. 5 shows a second-end powered transceiver according to an embodiment of the disclosure.

FIG. 6a shows a wireless coupling device comprising a first-end antenna longer than the second-end antenna, configured to admit different positions of the single second-end antenna.

FIG. 6b shows a wireless coupling device comprising a first-end antenna longer than the second-end antenna, configured for simultaneously coupling several second-end antennas.

FIG. 7a shows a first-end powering transceiver comprising a plurality of first-end antennas, covering a surface larger than that of the second-end antenna configured to admit different positions of a single second-end antenna.

FIG. 7b shows a first-end powering transceiver comprising a plurality of first-end antennas, covering a surface larger than that of the second-end antenna configured for simultaneously coupling several second-end antennas.

FIG. 8a shows the electromagnetic field generated by the first-end powering transceiver and the electromagnetic field generated by the second-end powered transceiver.

FIG. 8b shows a dispersion of the electromagnetic field generated by the first-end powering transceiver when the wireless coupling device is surrounding or close to metal parts.

FIG. 8c shows the wireless coupling device, wherein the first-end powering transceiver comprises a ferrite configured close to the first-end antenna to confine the electromagnetic field emitted by the first-end powering transceiver towards the second-end antenna of the second-end powered transceiver.

### DETAILED DESCRIPTION OF THE DRAWINGS

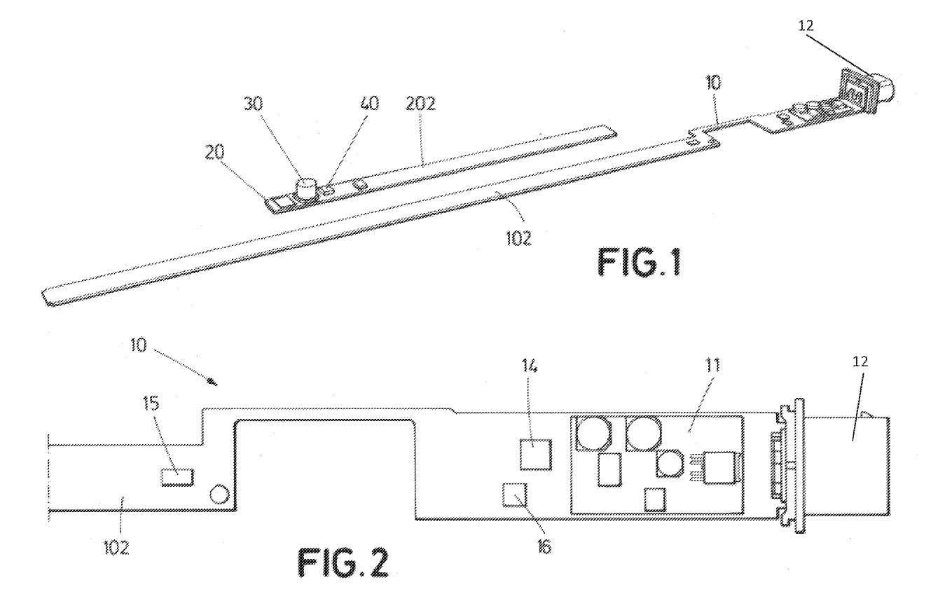

FIG. 1 shows a wireless coupling in accordance with one embodiment described in the present disclosure. In the coupling, a first-end powering transceiver 10 communicates with one or more second-end powered transceivers 20, 20′ (in FIG. 1, only one second-end powered transceiver 20 is illustrated). The first-end powering transceiver 10 is preferably located in a fixed position within the vehicle, such as, but without limitation, on the dashboard of the vehicle, on a door trim, on a cargo trim, on a floor carpet, on a pillar, or on the ceiling of the vehicle. The first-end powering transceiver 10 is connected to the wiring system of the vehicle, from which the first-end powering transceiver 10 is powered. Each second-end powered transceiver 20, 20′ is designed to be disposed in a vehicle interior part, such as an overhead console, door trim bezel, or others. That is to say, each second-end powered transceiver 20, 20′ is associated to or integrated into a vehicle interior part. An electronic device 30 is disposed either, attached to, or integrated in the vehicle interior part in which the second-end powered transceiver 20 is disposed, such that the wireless coupling device enables the vehicle to communicate with the electronic devices 30 disposed in one or more vehicle interior parts.

The wireless coupling implements a Near Field Communication (NFC) technology. Data can be exchanged between the first-end powering transceiver 10 and the one or more second-end powered transceivers 20, 20′ via the RF signal.

FIG. 2 shows in detail a portion of the first-end powering transceiver 10 with a certain first-end impedance Z₁ when working at the transmission frequency. The first-end powering transceiver 10 comprises: connection means 12 for electrically connect to a wiring system of the vehicle; a first-end ECU 11, a first-end RF transceiving means 14, a first-end EMC filter 16 and a first-end antenna 102 showing a theoretical first-end antenna impedance Z₁ₜₐ at the transmission frequency. The first-end RF transceiving means 14 contains transmitter and receiver circuitries configured to perform the operations associated to the generation and handle of radio transmit signals and radio receive signals, respectively. Examples of such operations are demodulation and filtering of receive signal and modulation and generation of transmit signal.

The second-end powered transceiver 20 is configured to operate within a range of radio frequency of the RF signal emitted by the first-end antenna 102 of the first-end powering transceiver 10. The second-end powered transceiver 20 shows certain second-end impedance Z₂ when working at the transmission frequency. The second-end powered transceiver 20 comprises second-end RF transceiving means 24 and a second-end antenna 202 with a theoretical second-end antenna impedance Z₂ₜₐ at the transmission frequency.

The second-end powered transceiver 20 is powered by the RF signal emitted by the first-end antenna 102.

The general operation of the wireless coupling is as follows: the first-end RF transceiving means 14 of the first-end powering transceiver 10 generates and modules in frequency a signal and provides the modulated signal to the first-end antenna 102, which creates an electromagnetic field when it receives the modulated signal. In turn, when the interior part is properly placed in the vehicle at its working position, consequently the second-end antenna 202 is in the electromagnetic field generated by the first-end antenna 102, and additionally to this, the second-end powered transceiver 20 is working within the range of operation of the first-end powering transceiver 10, the second-end powered transceiver 20 receives energy/power emitted by the first-end powering transceiver 10, enabling this way the feeding of the electronic devices 30 connected thereto. Data transmission between both ends is also enabled.

In order for the wireless coupling device to perform correctly, the second-end powered transceiver 20 must be situated within the range of the radio frequency field emitted by the first-end antenna 102 of the first-end powering transceiver 10.

Besides the first-end impedance Z1 of the first-end powering transceiver 10 must be the same as the second-end impedance Z2 of the second-end powering transceiving order for the energy not to be reflected, nor dissipated. In other words, the energy transmission efficiency from the first-end RF transceiving means 14 to the second-end antenna 202 of the second-end powered transceiver 20 is determined by the principle of impedances equality. The problem is that some factors may cause an impedance and/or frequency mismatch, which affects either, the efficiency of the transmission of power from the first-end powering transceiver 10 to the second-end powered transceiver 20, and the quality of the signals emitted and received by both transceivers. Among others, these factors can be, the relative position between the first-end powering transceiver 10 and the one or more second-end powered transceivers 20, 20′ mainly the distance between them, the metallic environment in the vehicle surrounding the fist-end antenna 102 and the second-end antenna 202, the environmental conditions, the ageing of the components, the variations in design, materials, and requirements of either, the different kinds of inner part, and the different vehicle models. Thus to achieve a good level of quality of signal and power, ad-hoc first-end powering transceivers 10, and ad-hoc second-end powered transceivers 20,20′ must be designed for every combination of vehicle model and vehicle interior part, what impedes the standardization of this kind of coupling devices.

In order to cope with this problem, the wireless coupling of the disclosure comprises a matching circuit 15 for compensating potential impedance and frequency mismatches. In other words, for matching the impedance and resonant frequency of both ends. This allows the use of the same first-end powering transceiver 10 and second-end powered transceiver 20 for different interior parts and vehicle models. The impedance matching circuit 15 may be comprised either in the first-end powering transceiver 10 or in the second-end powered transceiver 20. Thus, it is possible to choose in which transceiver incorporate the matching circuit 15 and design the other transceiver as a standard circuit, adjusting the impedances of both ends with a simple impedance matching circuit 15. For example if the impedance matching circuit 15 is incorporated in the first-end powering transceiver 10 it is possible to standardize the circuits of the second-end powered transceivers 20, 20′ incorporated in the different vehicle interior parts. Even when the transceiver is incorporating the matching circuit 15, only a small part, corresponding to the matching circuit, must be ad-hoc designed for each combination of coupling between a specific interior part and a specific vehicle model, or for a specific application, whilst the rest of the circuit keeps standard.

The matching circuit 15 has an impedance Zc. The matching circuit 15 is disposed to compensate any deviation from the theoretical first-end antenna impedance Z₁ₜₐ, or from the theoretical second-end antenna impedance Z₂ₜₐ, due to real working conditions. This first-end antenna 102 or second-end antenna 202 are manufactured with a first-end antenna design impedance Z_{1da}, or a second-end antenna design impedance Z_{2da}, more inductive than the corresponding theoretical impedance Z₁ₜₐ of the first-end antenna 102 or of the theoretical impedance Z₂ₜₐ of the second-end antenna 202. The combination of the design impedance Z_{1da} of the first-end antenna 102 or of the design impedance Z_{2da} of the second-end antenna 202, and the impedance Zc of the matching circuit 15 matches the theoretical first-end antenna impedance Z₁ₜₐ or the theoretical second-end antenna impedance Z₂ₜₐ.

The matching circuit 15 is advantageously implemented by means of capacitive components, avoiding any use of inductive ones. When the matching circuit 15 is comprised in the first-end powering transceiver 10 the first-end antenna 102 is manufactured to have a design impedance Z_{1da} more inductive than the theoretical impedance Z₁ₜₐ of the first-end antenna 102 and when the matching circuit 15 is comprised in the second-end powered transceiver 20 the second-end antenna 202 is manufactured to have a design impedance Z_{2da} more inductive than the theoretical impedance Z₂ₜₐ of the second-end antenna 102. In some embodiments of the disclosure, the matching circuit 15 is made of at least one capacitive component.

In preferred embodiments, as shown in FIG. 2, the matching circuit 15 is implemented at the first-end powering transceiver 10.

FIG. 4 shows a scheme of the equivalent circuit in terms of impedance of the first-end powering transceiver 10 of FIG. 1, in which the first-end RF transceiving means 14 has been modeled as a voltage source and a C-R group (Cᵢₙₚᵤₜ, Rᵢₙₚᵤₜ, in parallel), the first-end antenna 102 has been modeled as a R-L group (Ra, La, in series). A matching circuit 15, modeled as a R-C group (Cs, Cs, Cp and Rp) has been implemented between the first-end RF transceiving means 14 and the first-end antenna 102.

In some embodiments of the disclosure the vehicle interior part is detachable by the user, for example, allowing its replacement with other similar interior parts with other functionalities or electronic devices 30, according to the user preferences and configurations, and can be placed as well in different positions inside the vehicle or even used outside the vehicle. The vehicle interior part in which the second-end powered transceiver 20 is disposed may comprise one or more electronic devices 30 (sensors, actuators, batteries, displays, tablets or others).

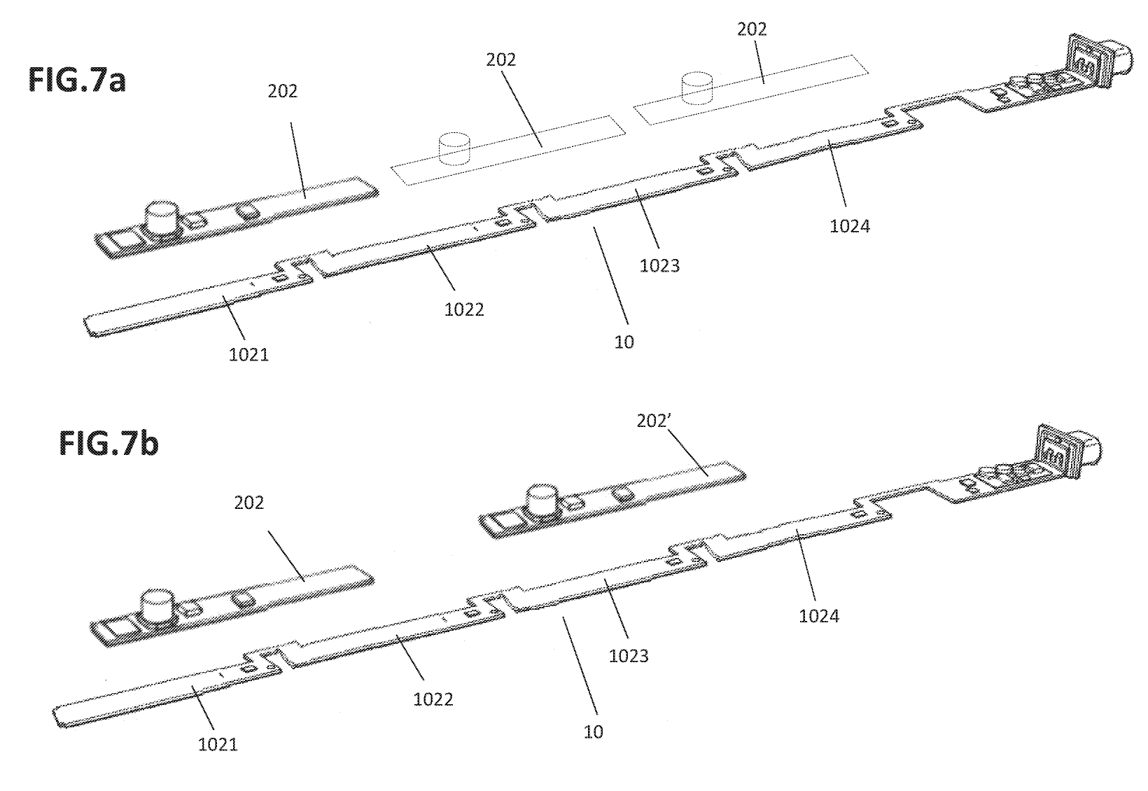

In some embodiments, the first-end powering transceiver 10 is larger than the second-end powered transceiver 20, in such a way that it allows different relative working positions for the vehicle interior part in the vehicle. In those cases, the first-end powering transceiver 10 can advantageously include a combination of several first-end antennas 1021, 1022, 1023, 1024 as shown in FIGS. 7a and 7b.

Turning back to FIG. 1, the electronic device 30 disposed in the vehicle interior part and connected to the second-end powered transceiver 20 is powered from the RF signal emitted by the first-end powering transceiver 10, at the time that it exchanges some data with the vehicle (CPU).

The first-end powering transceiver 10 may transmit data and/or instructions from the vehicle to the electronic device 30 of the vehicle interior part through the second-end powered transceiver 20 to which the electronic device 30 is connected.

The second-end powered transceiver 20 may transmit data and/or instructions from the electronic device 30 of the vehicle interior part to the vehicle (through the first-end powering transceiver 10, which receives the data and/or instructions from the second-end powered transceiver 20).

The first-end powering transceiver 10 and the second-end powered transceiver 20 may be configured to exchange data and/or instructions in a bidirectional way.

In preferred embodiments, the Near Field Communication (NFC) technology is a RFID technology, operable in the frequency band of 13.56 MHz.

The first-end powering transceiver 10 may passively detect and identify the second-end powered transceiver 20 as a RFID tag once both transceivers are coupled each other, that is, when the second-end antenna 202 is working within the radio frequency range of the RF signal, and within the scope of the electromagnetic field generated by the first-end antenna 102. This way, it is possible to detect when the interior part is coupled, which interior part is coupled, and even in which position the interior part is coupled.

The second-end powered transceiver 20 can comprise a memory 40 configured to store data associated to the second-end powered transceiver 20 and/or data associated to the electronic device 30 disposed in the vehicle interior part to which the second-end powered transceiver 20 is attachable. This data can be, for example, a code or identifier ID, or a set of configuration data according to the user preferences, of the electronic device 30 attached to the second-end powered transceiver 20. This data can be used, for example, by the first-end powering transceiver 10 to know with which second-end powered transceiver 20 it is communicating or which configuration for a specific application should be used according to the user preferences. The memory 40 may be used by any application implemented in either, the second-end powered transceiver 20, for example in the second-end ECU, or the first-end powering transceiver 10, in order to perform internal operations requiring, for example, the temporal storing data received by a sensor, or sending data to the first-end powering transceiver 10. Depending of the kind of memory 40 chosen, this memory 40 may be as well powered from the power of the RF signal emitted by the first-end antenna 102 of the first-end powering transceiver 10.

The second-end powered transceiver 20 may comprise energy storing means, for example a battery 50, configured to be rechargeable from power of the RF signal emitted by the first-end antenna 102 of the first-end powering transceiver 10. The stored energy may be used to power the electronic devices 30 connected to the second-end powered transceiver 20, when the interior part is not attached to the vehicle, and then the second-end powered transceiver 20 is out of the operation range of the first-end powering transceiver 10. While the second-end powered transceiver 20 is within the operation range of the first-end powering transceiver 10, and therefore the wireless coupling is in operation, the energy storing means collects from the first-end powering transceiver 10 as much energy/power as possible. Similarly, when the second-end powered transceiver 20 is not in the operation range of the first-end powering transceiver 10, the electronic devices 30 connected to the second-end powered transceiver 20 use the energy previously stored in the energy storing means. Memory 40 can also obtain the power it needs from the energy storing means.

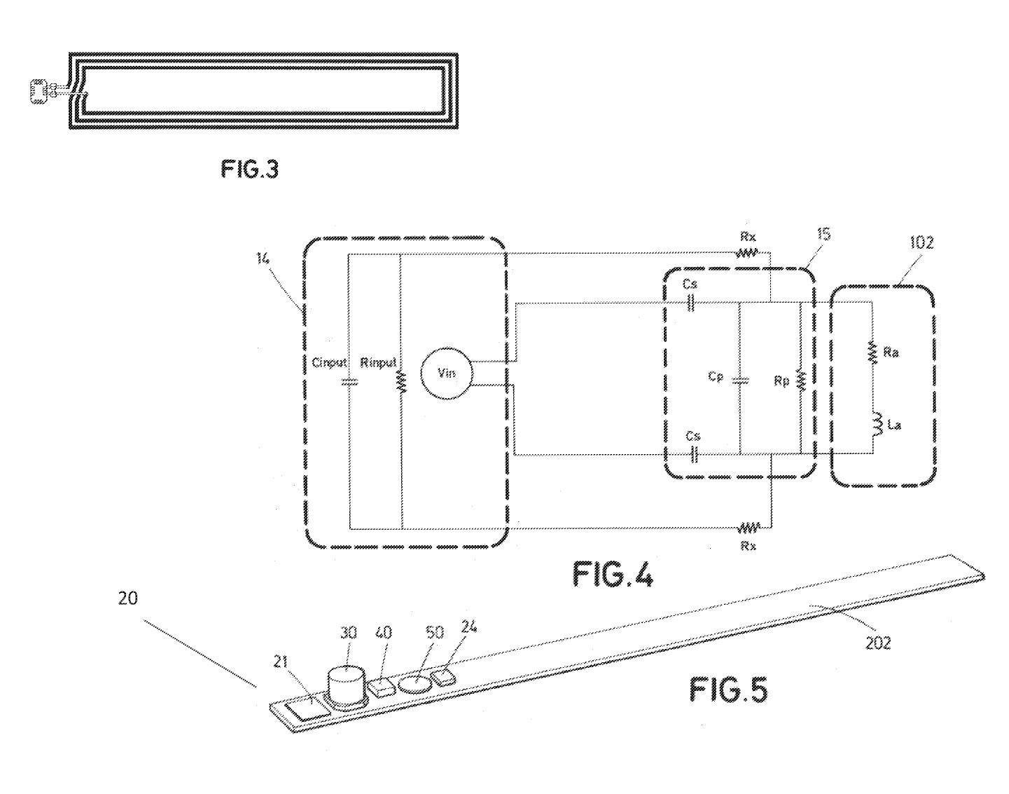

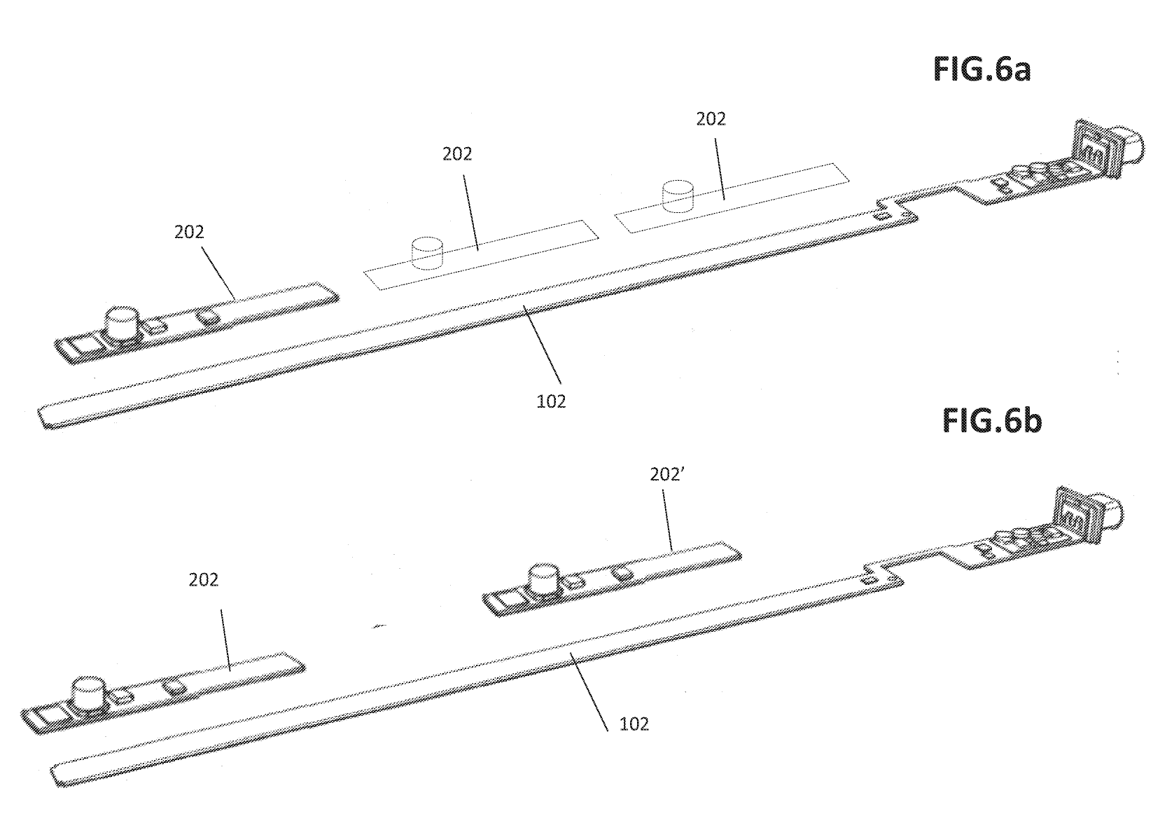

In embodiments of the disclosure, the first-end antenna 102 and the second-end antenna 202 are respectively implemented by means of a loop. It has been observed that the antenna geometry that generates the largest electromagnetic field, and therefore is capable of transmitting energy at a greater distance, is the loop geometry. FIG. 3 shows a possible implementation of an antenna loop, suitable for both the first-end antenna 102 and the second-end antenna 202.

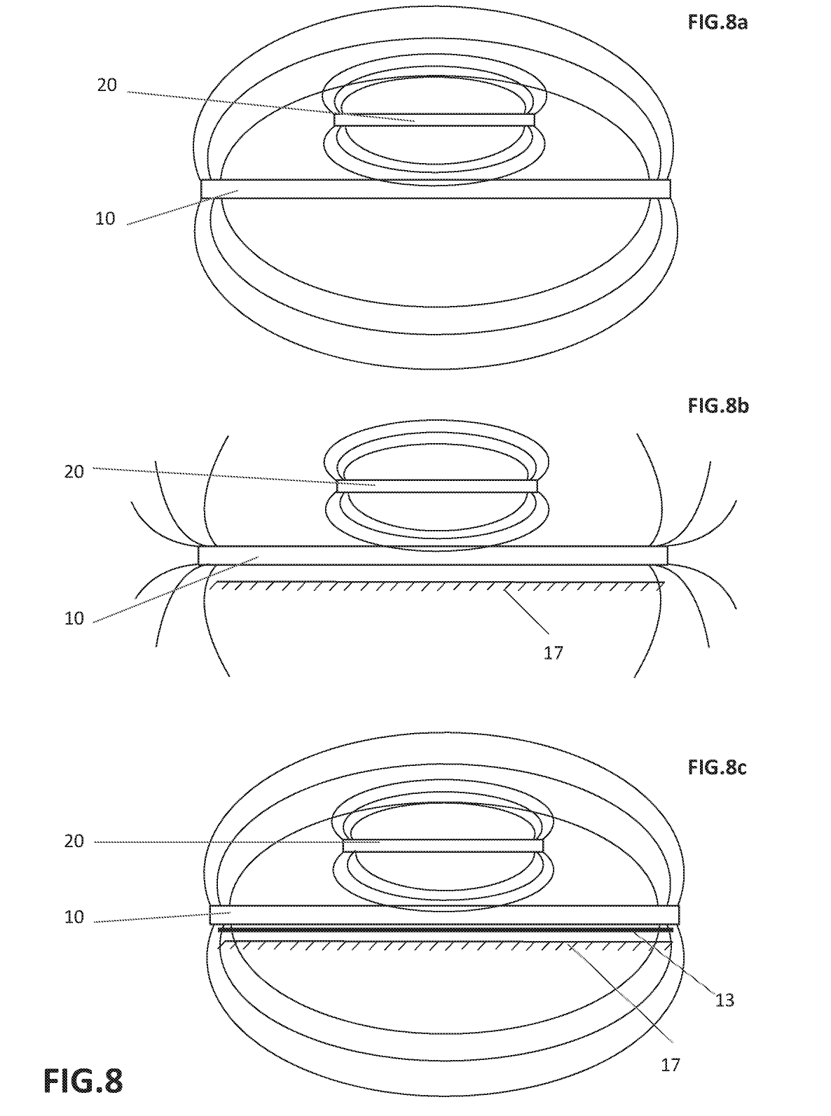

As shown in FIGS. 8a-8c, in some embodiments, when metal parts 17 are close to, or surrounding the wireless coupling, in order to prevent too much dispersion of the electromagnetic field generated by the first-end powering transceiver 10 (see FIG. 8b), a ferrite 13 can be advantageously disposed close to the first-end antenna 102, improving this way, its global efficiency, that is, the signal quality and the amount of power transmitted from the first-end powering transceiver 10, to the second-end powered transceiver 20. The ferrite has the effect of confining the electromagnetic field emitted by the first-end powering transceiver towards the second-end antenna of the second-end powered transceiver (see FIG. 8c).

The electronic device 30 comprised in the vehicle interior part and connected to the second-end powered transceiver 20 may be, for example, a sensor, such as a pressure sensor, a temperature sensor, a presence sensor, an actuator, such as a push button or a tactile actuator, a lighting or signaling component, a display, a tablet, etc. For example, a light console may have for example two push buttons, which are electronic devices 30 connected to a second-end powered transceiver 20. This way, the status of the light console (on/off) may be registered (stored) in the memory 40 of the second-end powered transceiver 20, because the status of the light console is determined by the push buttons, for example, pressed or released. So that, the status of the light console is one of the specific data that the second-end powered transceiver 20 may send via a RF signal emitted in this case by the second-end antenna 202 to the first-end antenna 102 associated to the first-end powering transceiver 10. The light console may have also a battery 50. The battery 50 may be another electronic device 30 connected to a second-end powered transceiver 20. The battery 50 of the light console may also be rechargeable by part of the power received by the second-end powered transceiver 20 from the first-end powering transceiver 10. Because the battery 50 is connected to the second-end powered transceiver 20, the status of the battery 50 or a level of charge (for example represented by several bits) is registered (stored) in the memory 40 of the second-end powered transceiver 20. So that, the status or level of the battery 50 is another specific data that the second-end powered transceiver 20 may send via the RF signal to the first-end powering transceiver 10, for example, when the first-end powering transceiver 10 interrogates the second-end powered transceiver 20.

The wireless coupling of this disclosure is designed to be installed in the vehicle interior. The vehicle may comprise several vehicle interior parts. At least one of the vehicle interior part comprises an electronic device 30. The first-end powering transceiver 10 of the wireless coupling device is located in a fixed position within the vehicle, while the second-end powered transceiver 20 of the wireless coupling device is attached to the vehicle interior part.

1. A wireless coupling, based on NFC technology, working at a given transmission frequency, for coupling a vehicle with an electronic device disposed in a vehicle interior part for simultaneously feeding said electronic device from said vehicle, and data exchanging between both of them, the wireless coupling comprising:
a first-end powering transceiver located in a fixed position within the vehicle and showing certain first-end impedance Z₁ when working at the transmission frequency, the first-end powering transceiver comprising
connection means electrically connectable to a wiring system of the vehicle,
a first-end ECU,
a first-end RF transceiving means,
a first-end EMC filter, and
a first-end antenna with a theoretical first-end antenna impedance Z₁ₜₐ at the transmission frequency;
a second-end powered transceiver configured to be disposed in the vehicle interior part in which said electronic device is disposed, said electronic device being connected to the second-end powered transceiver and showing certain second-end impedance Z₂ when working at the transmission frequency, said second-end powered transceiver being configured to operate in a radiofrequency range emitted by the first-end antenna of the first-end powering transceiver, the second end powered transceiver comprising
a second-end RF transceiving means, and
a second-end antenna with a theoretical second-end antenna impedance Z₂ₜₐ at the transmission frequency;
wherein the wireless coupling further comprises a matching circuit with an impedance Zc, said matching circuit being arranged to compensate any deviation from the theoretical first-end antenna impedance Z₁ₜₐ, or from the theoretical second-end antenna impedance Z₂ₜₐ, due to real working conditions, the matching circuit being connected to the first-end antenna or to the second-end antenna, the first-end antenna or the second-end antenna (202), having respectively a first-end antenna design impedance Z_{1da} or a second-end antenna design impedance Z_{2da}, more inductive than the corresponding theoretical first-end antenna impedance Z₁ₜₐ or than the theoretical second-end antenna impedance Z₂ₜₐ, such that the combination of the design first-end antenna impedance Z_{1da}, or of the design second-end antenna impedance Z_{2da}, and the impedance Zc of the matching circuit matches the theoretical first-end antenna impedance Z₁ₜₐ or the theoretical second-end antenna impedance Z₂ₜₐ.

2. The wireless coupling of claim 1, wherein the second-end powered transceiver comprises a second-end ECU.

3. The wireless coupling of claim 1 wherein the vehicle interior part is detachable from the vehicle.

4. The wireless coupling of claim 1, wherein the data exchanging between the first-end powering transceiver and the second-end powered transceiver comprises data and/or instructions transmission from the vehicle to the electronic device of the vehicle interior part.

5. The wireless coupling of claim 1, wherein the data exchanging between the second-end powered transceiver and the first-end powering transceiver comprises data and/or instructions transmission from the electronic device of the vehicle interior part to the vehicle.

6. The wireless coupling of claim 1, wherein the first-end powering transceiver and the second-end powered transceiver are configured to exchange data and/or instructions in a bidirectional way.

7. The wireless coupling of claim 1, wherein the first-end powering transceiver is configured to passively detect and/or identify the second-end powered transceiver, when they are coupled to each other.

8. The wireless coupling according to claim 7, wherein the first-end powering transceiver is configured to passively identify the second-end powered transceiver as a RFID tag.

9. The wireless coupling according to of claim 1, wherein said first-end antenna and/or said second-end antenna are respectively implemented by means of a loop.

10. The wireless coupling of claim 1, wherein the second-end powered transceiver comprises a memory configured to store data related to the second-end powered transceiver and/or to the electronic device.

11. The wireless coupling of claim 1, wherein the second-end powered transceiver comprises a battery configured to be rechargeable from power of the RF signal emitted by the first-end antenna of the first-end powering transceiver.

12. The wireless coupling of claim 1, wherein the impedance matching circuit is self-adjusting, tuning its capacitive impedance to compensate any mismatch related to impedance variations due to design, environmental, or ageing factors.

13. The wireless coupling of claim 1, wherein the impedance matching circuit is comprised in the first-end powering transceiver.

14. The wireless coupling of claim 1, wherein the first-end powering transceiver comprises a ferrite configured close to the first-end antenna to confine the electromagnetic field emitted by the first-end powering transceiver towards the second-end antenna.

15. The wireless coupling of claim 1, wherein the first-end antenna is longer than the second-end antenna, configured for either, admitting different positions of a single second-end antenna, or simultaneously coupling several second-end antennas.

16. The wireless coupling of claim 1, wherein the first-end powering transceiver comprises a plurality of first-end antennas, covering a surface larger than that of the second-end antenna, configured for either, admitting different positions of a single second-end antenna, or simultaneously coupling several second-end antennas.

17. A vehicle comprising a vehicle part comprising an electronic device, the vehicle further comprising the wireless coupling of claim 1, wherein said first-end powering transceiver is located in a fixed position within the vehicle and said second-end powered transceiver is attached to said vehicle interior part.
